(19) United States
(12) Patent Application Publication
(10) Pub. No.: US 2012/0086672 A1
(43) Pub. Date: Apr. 12, 2012

(54) METHOD OF LOCATING TOUCH POSITION

(75) Inventors: Hung-Wei Tseng, Hsinchu City (TW); Cheng-Chiu Pai, Changhua County (TW); Shu-Wen Tzeng, Changhua County (TW); An-Thung Cho, Hualien County (TW)

(73) Assignee: AU OPTRONICS CORPORATION, Hsinchu (TW)

(21) Appl. No.: 12/970,971

(22) Filed: Dec. 17, 2010

(30) Foreign Application Priority Data
Oct. 8, 2010 (TW) 99134411

(51) Int. Cl. G06F 3/042

(52) U.S. Cl. 345/175

(57) ABSTRACT

A method for locating a touch position is provided. The method is adaptable to an optical touch panel, wherein the optical touch panel has a plurality of visible light sensors and a plurality of corresponding invisible light sensors that are arranged as an array. In the present method, sensing signals of the visible light sensors and the invisible light sensors are read. The sensing signal of each visible light sensor is converted into a first binary code according to a first setting parameter, and the sensing signal of each invisible light sensor is converted into a second binary code according to a second setting parameter and a third setting parameter. An AND operation is performed on all the first binary codes and all the second binary codes to obtain a plurality of logic operation values, so as to locate a position touched by a user on the optical touch panel.

### CROSS-REFERENCE TO RELATED APPLICATION

This application claims the priority benefit of Taiwan application serial no. 99134411, filed on Oct. 8, 2010. The entirety of the above-mentioned patent application is hereby incorporated by reference herein and made a part of this specification.

### BACKGROUND OF THE INVENTION

1. Field of the Invention

The invention generally relates to a touch technology, and more particularly, to a method of locating a touch position on an optical touch panel.

2. Description of Related Art

Along with the rapid advancement of information and wireless communication technologies and the widespread of information appliances, the input devices of many information products have been changed from conventional keyboards and mice to touch panels in order to achieve a more personalized operation experience. Presently, touch panels are generally categorized into resistive touch panels, capacitive touch panels, surface acoustic wave (SAW) touch panels, electromagnetic touch panels, and optical touch panels, etc.

Taking an optical touch panel as an example, an invisible light source and an invisible light sensor may be disposed in the optical touch panel for locating positions touched by a user on the touch surface. To be specific, when the user touches the touch surface with his or her finger, the invisible light emitted by the invisible light source is reflected. Thus, the invisible light sensor disposed below the touch point between the user's finger and the touch surface receives a sensing signal and determines the position touched by the user on the optical touch panel according to the sensing signal. However, such an optical touch panel may produce a misoperation when the ambient light is too intensive.

### SUMMARY OF THE INVENTION

Accordingly, the invention is directed to a method of locating a touch position, wherein any misoperation produced by an optical touch panel due to intensive ambient light is avoided.

The invention provides a method of locating a touch position. The method is adaptable to an optical touch panel, wherein the optical touch panel has a plurality of visible light sensors and a plurality of corresponding invisible light sensors that are arranged as an array. The present method includes following steps. Sensing signals of the visible light sensors and the invisible light sensors are read. The sensing signal of each visible light sensor is converted into a first binary code according to a first setting parameter, and the sensing signal of each invisible light sensor is converted into a second binary code according to a second setting parameter and a third setting parameter. A logic AND operation is performed on all the first binary codes and all the second binary codes to obtain a plurality of logic operation values, so as to determine a position touched by a user on the optical touch panel.

As described above, in the touch position locating method provided by the invention, a position touched by a user on an optical touch panel can be precisely located after an AND operation is performed on the first binary codes and the second binary codes respectively converted from sensing signals of the visible light sensors and the invisible light sensors. Thereby, the touch position can be located without being affected by the ambient light, and any misoperation produced by the optical touch panel due to intensive ambient light can be avoided.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating an optical touch panel to which a touch position locating method is adaptable according to an embodiment of the invention.

FIG. 2 is a top view of an optical touch panel according to an embodiment of the invention.

FIG. 3 is a flowchart illustrating a method of locating a touch position according to an embodiment of the invention.

FIG. 4 is a diagram illustrating a mean filtering method according to an embodiment of the invention.

FIG. 5 is a diagram illustrating a remedy mechanism according to an embodiment of the invention.

FIG. 6 is a diagram illustrating how a sensing signal of a visible light sensor is converted into a first binary code according to an embodiment of the invention.

FIG. 7 is a diagram illustrating how a sensing signal of an invisible light sensor is converted into a second binary code according to an embodiment of the invention.

FIGS. 8-10 are diagrams illustrating how sensing signals are converted into binary codes and how an AND operation is performed according to an embodiment of the invention.

FIG. 11 is a diagram illustrating the hardware structure for converting sensing signals into binary codes and performing an AND operation according to an embodiment of the invention.

FIG. 12 is a diagram illustrating the operation of an optical touch panel according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

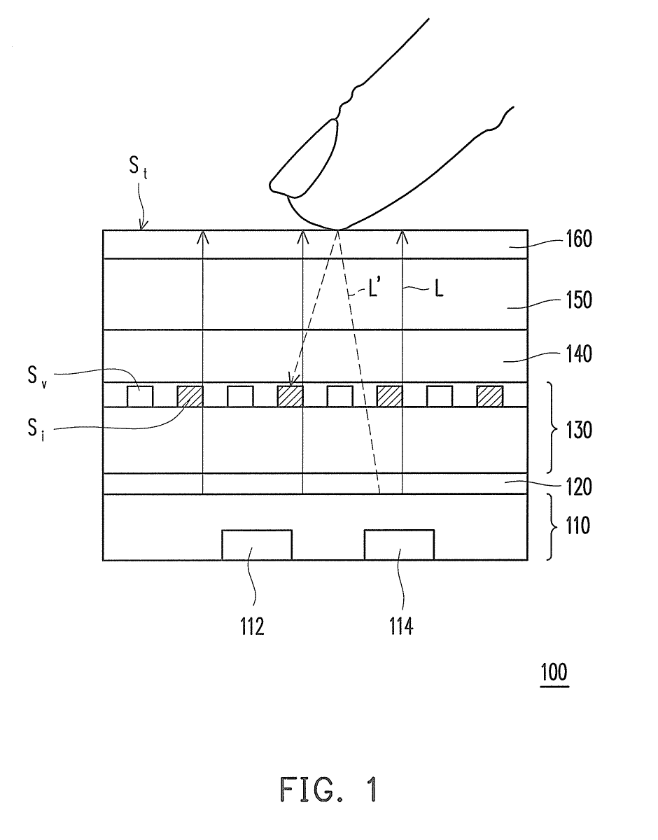

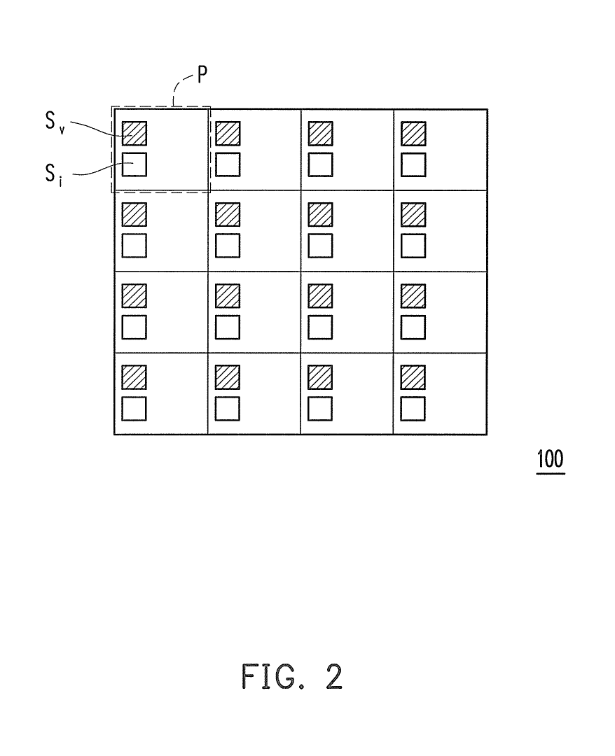

FIG. 1 is a diagram illustrating an optical touch panel to which a touch position locating method is adaptable according to an embodiment of the invention. Referring to FIG. 1, in the present embodiment, the optical touch panel 100 includes a plurality of visible light sensors Sᵥ and a plurality of corresponding invisible light sensors Sᵢ that are arranged as an array. For example, the optical touch panel 100 includes 4×4 visible light sensors Sᵥ arranged as an array and 4×4 invisible light sensors Sᵢ arranged as an array, and the visible light sensors Sᵥ are respectively corresponding to the invisible light sensors Sᵢ. Preferably, each visible light sensor Sᵥ and the corresponding invisible light sensor Sᵢ are located within the same pixel region P, as shown in FIG. 2.

Referring to FIG. 1, in the present embodiment, the optical touch panel 100 also includes a backlight source 110. The backlight source 110 has a visible light emitting device 112 and an invisible light emitting device 114. The visible light emitting device 112 is suitable for emitting a visible light beam L towards the touch surface Sₜ (i.e., a display surface) to display images. The invisible light emitting device 114 is suitable for emitting a invisible light beam L′ towards the touch surface Sₜ to locate touch positions.

In the present embodiment, the optical touch panel 100 may further include a lower polarizer 120, a thin film transistor (TFT) array substrate 130, a display medium layer 140, a color filter 150, and an upper polarizer 160. The lower polarizer 120 is disposed above the backlight source 110. The TFT array substrate 130 is disposed above the lower polarizer 120, and the TFT array substrate 130 has aforementioned invisible light sensors Sᵢ, visible light sensors Sᵥ, a plurality of TFTs (not shown), a plurality of data lines (not shown), and a plurality of scan lines (not shown). The color filter 150 is disposed above the TFT array substrate 130. The display medium layer 140 is disposed between the TFT array substrate 130 and the color filter 150. The upper polarizer 160 is disposed above the color filter 150.

However, the touch position locating method in the present embodiment is not limited to being applied to the optical touch panel 100 described above. Namely, the touch position locating method in the present embodiment can be applied to any optical touch panel that includes visible light sensors and invisible light sensors.

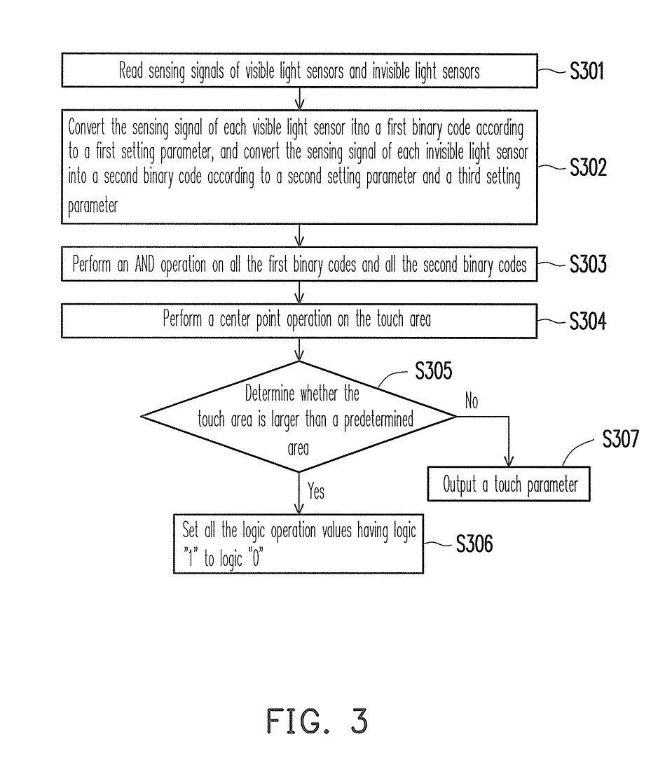

FIG. 3 is a flowchart illustrating a method of locating a touch position according to an embodiment of the invention. Referring to FIG. 3, the present method is adaptable to the optical touch panel 100 illustrated in FIG. 1, and which includes following steps. Sensing signals of the visible light sensors and the invisible light sensors are read (step S301). The sensing signal of each visible light sensor is converted into a first binary code according to a first setting parameter, and the sensing signal of each invisible light sensor is converted into a second binary code according to a second setting parameter and a third setting parameter (step S302). An AND operation is performed on all the first binary codes and all the second binary codes (step S303) to obtain a plurality of logic operation values, so as to locate a position touched by a user on the optical touch panel.

To be specific, the sensing signals Vᵥ, and Vᵢ of the visible light sensors Sᵥ and the invisible light sensors Sᵢ may be interfered by other signals (for example, signals input to the data lines) to produce noises. Thus, in the touch position locating method provided by the present embodiment, noises in the sensing signals Vᵥ and Vᵢ of the visible light sensors Sᵥ and the invisible light sensors Sᵢ can be eliminated through a mean filtering technique when the sensing signals of the visible light sensors Sᵥ and the invisible light sensors Sᵢ are read.

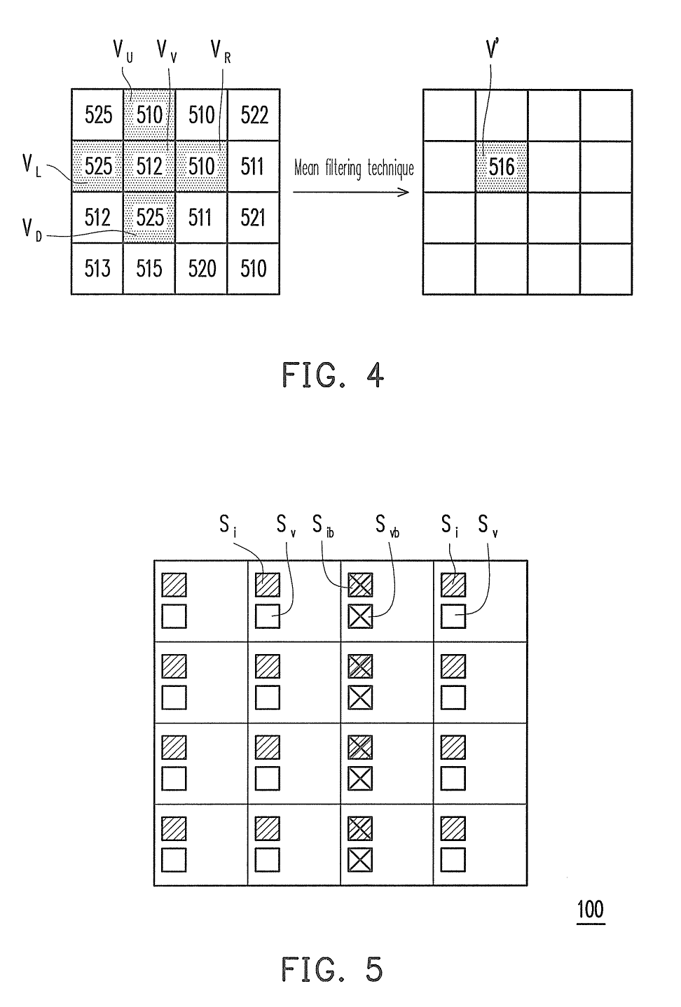

For example, if the optical touch panel 100 is in a dot inversion data writing mode, the sensing signal Vᵥ, (for example, a 512 analog-to-digital signal (512 ADC)) of each visible light sensor in the optical touch panel 100 is mean filtered into a mean V′(for example, a 516 ADC) of the sensing signals V_{U}, V_{D}, V_{L}, and V_{R} (for example, a 510 ADC, a 525 ADC, a 525 ADC, and a 510 ADC) of the adjacent four visible light sensors, so as to effectively eliminate the noises in the sensing signals Vᵥ of the visible light sensors Sᵥ, as shown in FIG. 4. Similarly, the noises in the sensing signals Vᵢ of the invisible light sensors Sᵢ can be effectively eliminated through the same technique. However, the invention is not limited thereto, and in other embodiments, the noises in the sensing signals Vᵥ of the visible light sensors Sᵥ and the sensing signals Vᵢ of the invisible light sensors Sᵢ may also be eliminated through other effective techniques.

It should be mentioned that the noises in the sensing signals Vᵥ of the visible light sensors Sᵥ and the sensing signals Vᵢ of the invisible light sensors Sᵢ may not be eliminated when the sensing signals Vᵥ, and Vᵢ are read. In other embodiments, the noises in the sensing signals Vᵥ of the visible light sensors Sᵥ and the sensing signals Vᵢ of the invisible light sensors Sᵢ may also be eliminated after the sensing signals Vᵥ and Vᵢ are read and before the sensing signals Vᵥ and Vᵢ are converted, namely, the noises in the sensing signals Vᵥ of the visible light sensors Sᵥ and the sensing signals Vᵢ of the invisible light sensors Sᵢ may be eliminated by the actual design requirement.

Additionally, during the manufacturing process of the optical touch panel 100, defects may be produced, and which may cause the visible light sensors Sᵥ and the invisible light sensors Sᵢ to be damaged (i.e., some of the visible light sensors Sᵥ and invisible light sensors Sᵢ may not be able to generate the sensing signals Vᵥ and Vᵢ). Thus, in the touch position locating method provided by the present embodiment, a remedy mechanism may be further adopted regarding the sensing signals Vᵥ and Vᵢ of the damaged visible light sensors Sᵥ and invisible light sensors Sᵢ before the sensing signals Vᵥ of the visible light sensors Sᵥ and the sensing signals Vᵢ of the invisible light sensors Sᵢ are converted.

To be specific, referring to FIG. 5, in the present embodiment, the sensing signals of the damaged visible light sensor S_{vb} are remedied according to the sensing signals Vᵥ of some undamaged visible light sensors Sᵥ, and the sensing signals of the damaged invisible light sensors S_{ib} are remedied according to the sensing signals Vᵢ of some undamaged invisible light sensors Sᵢ. Preferably, the sensing signals of the damaged visible light sensors S_{vb} are remedied according to the sensing signals Vᵥ of the visible light sensors Sᵥ adjacent to the damaged visible light sensors S_{vb}, and the sensing signals of the damaged invisible light sensors S_{ib} are remedied according to the sensing signals Vᵢ of the invisible light sensors Sᵢ adjacent to the damaged invisible light sensors S_{ib}.

For example, if a line defect is produced during the manufacturing process of the optical touch panel 100, and accordingly a specific row of visible light sensors S_{vb} and invisible light sensors S_{ib} are damaged therefore cannot generate the sensing signals Vᵥ and Vᵢ (as shown in FIG. 5), an interpolation operation is performed on the sensing signals Vᵥ of the undamaged visible light sensors Sᵥ located at the left and the right of a damaged visible light sensor S_{vb} to obtain an interpolation value, and the interpolation value is served as the sensing signal Vᵥ of the damaged visible light sensor S_{vb}. Similarly, an interpolation operation is performed on the sensing signal Vᵢ of the undamaged invisible light sensors Sᵢ located at the left and the right of a damaged invisible light sensor S_{ib} to obtain an interpolation value, and the interpolation value is served as the sensing signal Vᵢ of the damaged invisible light sensor S_{ib}. Accordingly, even if any defect is produced during the manufacturing process of the optical touch panel 100, the sensing signals Vᵥ and Vᵢ of all the visible light sensors Sᵥ and invisible light sensors Sᵢ can still be successfully read and used for locating touch positions.

In the present embodiment, after reading the sensing signals Vᵥ and Vᵢ of all the visible light sensors Sᵥ and invisible light sensors Sᵢ, the sensing signal Vᵥ of each visible light sensor Sᵥ is converted into a first binary code B₁ according to a first setting parameter Vₜₕ₁, and the sensing signal Vᵢ of each invisible light sensor Sᵢ is converted into a second binary code B₂ according to a second setting parameter Vₜₕ₂ and a third setting parameter Vₜₕ₃.

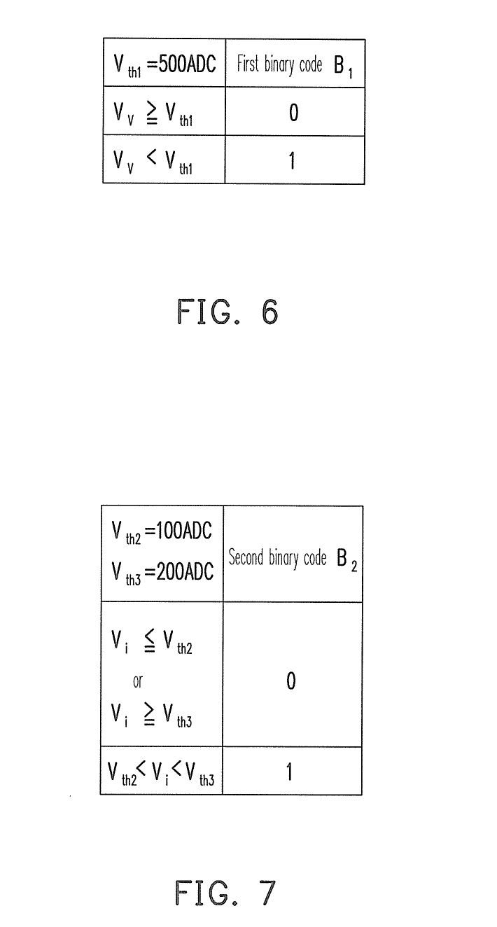

FIG. 6 is a diagram illustrating how a sensing signal Vᵥ of a visible light sensor Sᵥ is converted into a first binary code B₁ according to an embodiment of the invention. Referring to FIG. 6, for example, if the sensing signal Vᵥ of the visible light sensor Sᵥ is greater than or equal to the first setting parameter Vₜₕ₁ (for example, a 500 ADC, but not limited thereto), the sensing signal Vᵥ of the visible light sensor Sᵥ is converted into such a first binary code B₁ as logic “0”. In addition, if the sensing signal Vᵥ of the visible light sensor Sᵥ is smaller than the first setting parameter Vₜₕ₁ (for example, 500 ADC), the sensing signal Vᵥ of the visible light sensor Sᵥ is converted into such a first binary code B₁ as logic “1”.

FIG. 7 is a diagram illustrating how a sensing signal Vᵢ of an invisible light sensor Sᵢ is converted into a second binary code B₂ according to an embodiment of the invention. Referring to FIG. 7, for example, if the sensing signal Vᵢ of the invisible light sensor Sᵢ is smaller than or equal to the second setting parameter Vₜₕ₂ or greater than or equal to the third setting parameter Vₜₕ₃, the sensing signal Vᵢ of the invisible light sensor Sᵢ is converted into such a second binary code B₂ as logic “0”. In addition, if the sensing signal Vᵢ of the invisible light sensor Sᵢ is greater than the second setting parameter Vₜₕ₂ and smaller than the third setting parameter Vₜₕ₃, the sensing signal Vᵢ of the invisible light sensor Sᵢ is converted into such a second binary code B₂ as logic “1”.

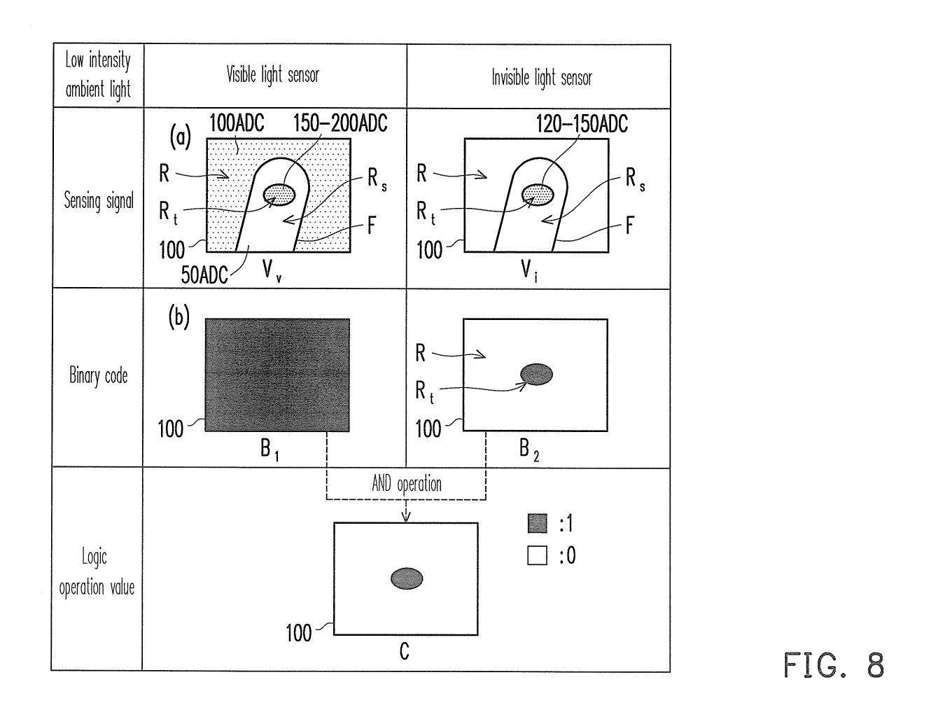

FIG. 8 is a diagram illustrating how the sensing signals Vᵥ and Vᵢ are converted into the binary codes B₁ and B₂ and how the AND operation is performed according to an embodiment of the invention. Referring to FIGS. 6-8, for example, with an ambient light of a low intensity (for example, 400 lumens), when a user touches a touch area Rₜ on the optical touch panel 100 with a finger F, the sensing signals Vᵥ of the visible light sensors Sᵥ within the touch area Rₜ may be 150 ADC-200 ADC. As shown in FIG. 6, the sensing signals Vᵥ of the visible light sensors Sᵥ within the touch area Rₜ are converted into first binary codes B₁ of logic “1” (denoted in black color in FIG. 8).

Additionally, the sensing signals Vᵥ of the visible light sensors Sᵥ within a shadow area R_{S} on the optical touch panel 100 that is covered but not touched by the user's finger F may be 50 ADC. As shown in FIG. 6, the sensing signals Vᵥ of the visible light sensors Sᵥ within the shadow area R_{S} are converted into first binary codes B₁ of logic “1” (denoted in black color in FIG. 8). Moreover, the sensing signals Vᵥ of the visible light sensors Sᵥ within aambient light area R on the optical touch panel 100 that is not covered or touched by the user's finger F may be 100 ADC. As shown in FIG. 6, the sensing signals Vᵥ of the visible light sensors Sᵥ within the ambient light area R are converted into first binary codes B₁ of logic “1” (denoted in black color in FIG. 8).

Meanwhile, the sensing signals V; of the invisible light sensors Sᵢ within the touch area Rₜ may be 120 ADC-150 ADC. As shown in FIG. 7, the sensing signals Vᵢ of the invisible light sensors Sᵢ within the touch area Rₜ are converted into second binary codes B₂ of logic “1” (denoted in black color in FIG. 8). In addition, the sensing signals Vᵢ of the invisible light sensors Sᵢ within the shadow area R_{S} may be smaller than 100 ADC. As shown in FIG. 7, the sensing signals Vᵢ of the invisible light sensors Sᵢ within the shadow area R_{S} are converted into second binary codes B₂ of logic “0” (denoted in white color in FIG. 8). Moreover, the sensing signals Vᵢ of the invisible light sensors Sᵢ within the ambient light area R may be smaller than 100 ADC. As shown in FIG. 7, the sensing signals Vᵢ of the invisible light sensors Sᵢ within the ambient light area R are converted into second binary codes B₂ of logic “0” (denoted in white color in FIG. 8).

After obtaining the binary codes B₁ and B₂ corresponding to all the sensing signals Vᵥ and Vᵢ, an AND operation is performed on all the first binary codes B₁ and all the second binary codes B₂ to obtain a plurality of logic operation values C (0 is denoted in black color, and 1 is denoted in white color) in the logic operation value field in FIG. 8. As shown in FIG. 8, the area having the logic operation values C as “1” (the black area) is the area actually touched by the user's finger F, and the area having the logic operation values C as “0” (the white area) is the area not touched by the user's finger F. In other words, the area touched by the user on the optical touch panel 100 can be determined according to the logic operation values C obtained by performing an AND operation on all the first binary codes B₁ and all the second binary codes B₂.

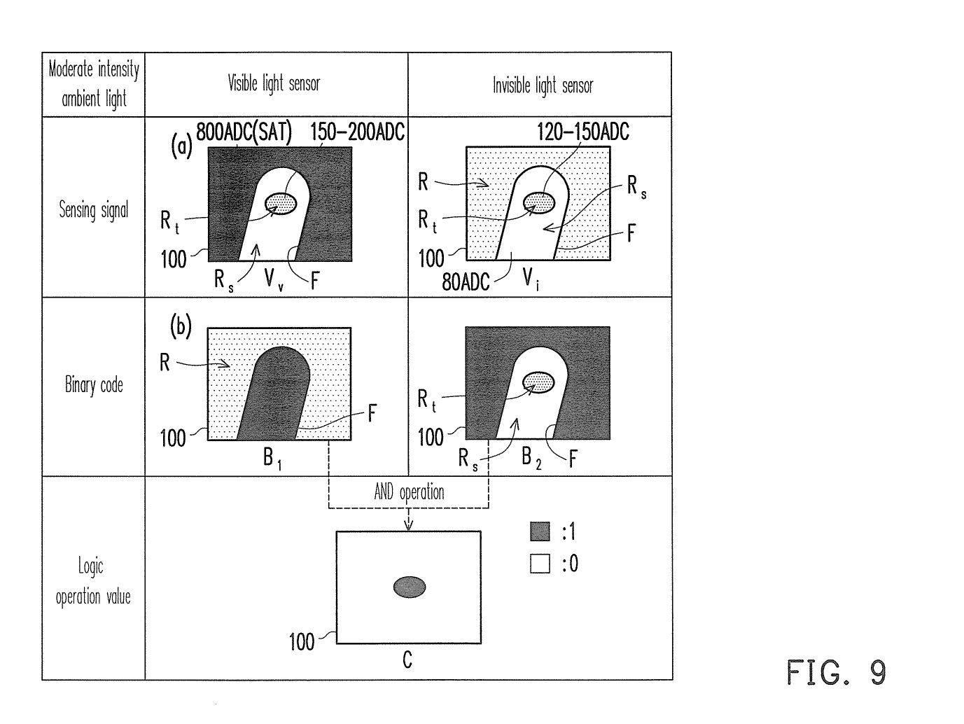

FIG. 9 is a diagram illustrating how the sensing signals Vᵥ and Vᵢ are converted into the binary codes Bᵢ and B₂ and how the AND operation is performed according to an embodiment of the invention. Referring to FIG. 6, FIG. 7, and FIG. 9, for example, with an ambient light of a moderate intensity (for example, 2000 lumens), when a user touches a touch area Rₜ on the optical touch panel 100 with a finger F, the sensing signals Vᵢ of the invisible light sensors Sᵢ within the touch area Rₜ may be 120 ADC-150 ADC. As shown in FIG. 7, the sensing signals Vᵢ of the invisible light sensors Sᵢ within the touch area Rₜ are converted into second binary codes B₂ of logic “1” (denoted in black color in FIG. 9).

In addition, the sensing signals Vᵢ of the invisible light sensors Sᵢ within a shadow area R_{S} on the optical touch panel 100 that is covered but not touched by the user's finger F may be 80 ADC. As shown in FIG. 7, the sensing signals Vᵢ of the invisible light sensors Sᵢ within the shadow area R_{S} are converted into second binary codes B₂ of logic “0” (denoted in white color in FIG. 9). However, because herein the ambient light has a higher intensity, the invisible light sensors Sᵢ within the ambient light area R receive more invisible ambient light so that the sensing signals Vᵢ of the invisible light sensors Sᵢ within the ambient light area R are greater (for example, 120 ADC-150 ADC). As shown in FIG. 7, the sensing signals Vᵢ of the invisible light sensors Sᵢ within the ambient light area R are converted into second binary codes B₂ of logic “1” (denoted in black color in FIG. 9).

It should be noted that if the area touched by the user's finger F is determined according to all the second binary codes B₂ converted from the sensing signals Vᵢ of the invisible light sensors Sᵢ, a wrong result will be obtained. To be specific, if the area actually touched by the user's finger F is located according to all the second binary codes B₂, the area Rₜ which is actually touched by the user's finger F and the ambient light area R which is not touched by the user's finger F are both determined to be the area touched by the user's finger, so that a misoperation of the optical touch panel 100 is induced.

However, in the present embodiment, an AND operation is performed on all the first binary codes B₁ (obtained through the technique illustrated in FIG. 8) and all the second binary codes B₂ to obtain a plurality of logic operation values C, so as to effectively locate a area touched by the user on the optical touch panel 100. To be specific, the second binary codes B₂ of logic “1” corresponding to the ambient light area R are converted into logic operation values C of logic “0” through the AND operation performed on all the first binary codes B₁ and all the second binary codes B₂, so that the area (the black area) having the logic operation values C as “1” is exactly the area actually touched by the user. In other words, by performing the AND operation on all the first binary codes B₁ and all the second binary codes B₂, the affection of the ambient light is effectively reduced so that the area actually touched by the user can be correctly determined and any misoperation of the optical touch panel 100 can be avoided.

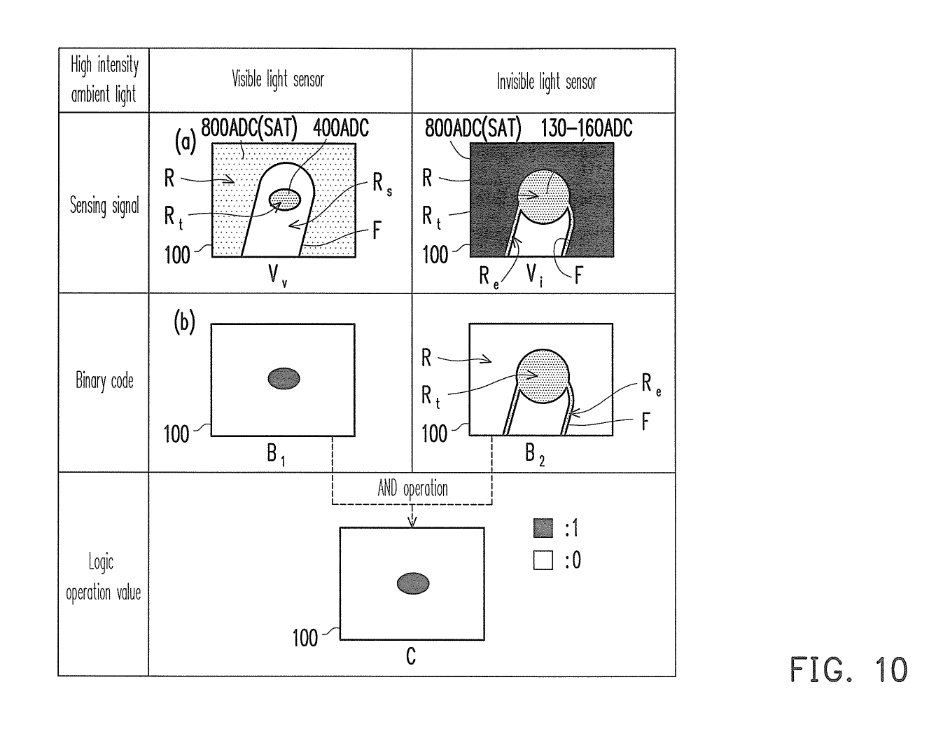

FIG. 10 is a diagram illustrating how the sensing signals Vᵥ and Vᵢ are converted into the binary codes B₁ and B₂ and how the AND operation is performed according to an embodiment of the invention. Referring to FIG. 6, FIG. 7, and FIG. 10, for example, with an ambient light of a higher intensity (for example, 5000 lumens), when the user touches a touch area Rₜ on the optical touch panel 100 with a finger F, the sensing signals V; of the invisible light sensors Sᵢ within the touch area Rₜ may be 130 ADC-160 ADC. As shown in FIG. 7, the sensing signals Vᵢ of the invisible light sensors Sᵢ within the touch area Rₜ are converted into second binary codes B₂ of logic “1” (denoted in black color in FIG. 10). However, because herein the ambient light is very intensive, the area Rₑ around the edge of the user's finger F (not in contact with the optical touch panel 100) receives a lot of invisible ambient light, so that the sensing signals Vᵢ of the invisible light sensors Sᵢ within the area Rₑ are greater (for example, 130 ADC-160 ADC). As shown in FIG. 7, the sensing signals Vᵢ of the invisible light sensors Sᵢ within the area Rₑ are also converted into second binary codes B₂ of logic “1” (denoted in black color in FIG. 10).

Similarly, if the area touched by the user is determined according to all the second binary codes B₂ converted from the sensing signals Vᵢ of the invisible light sensors Sᵢ, an incorrect result will be obtained. To be specific, if the area touched by the user's finger F is determined according to all the second binary codes B₂, the area Rₜ touched by the user's finger F and the area Rₑ around the edge of the user's finger F (not in contact with the optical touch panel 100) are both determined to be the area actually touched by the user's finger F, so that a misoperation of the optical touch panel 100 is induced.

However, in the present embodiment, even with a highly intensive ambient light, the affection of the ambient light can be effectively reduced by performing an AND operation on all the first binary codes B₁ (obtained through the technique illustrated in FIG. 8) and all the second binary codes B₂, so that the area actually touched by the user can be precisely determined. Moreover, in the present embodiment, even if the ambient light changes drastically, the affection of the ambient light can still be greatly reduced by performing an AND operation on all the first binary codes B₁ and all the second binary codes B₂, so that the area actually touched by the user can still be correctly determined according to the logic operation values C.

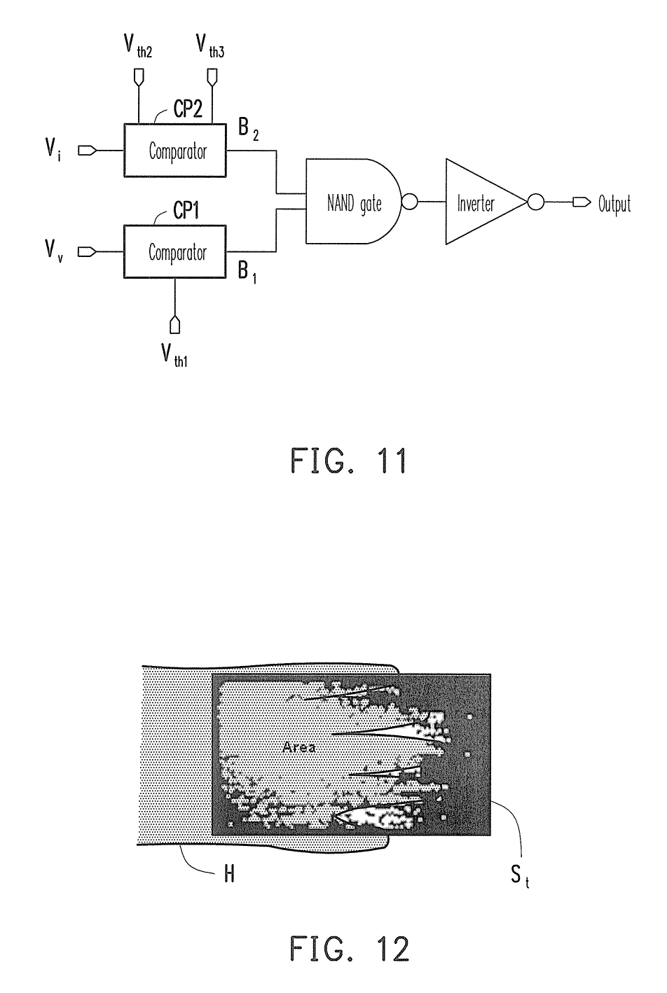

It should be mentioned herein that in the present embodiment, the operations of converting the sensing signals Vᵥ of the visible light sensors Sᵥ into the first binary codes B₁, converting the sensing signals Vᵥ of the invisible light sensors Sᵢ into the second binary codes B₂, and performing the AND operation on all the first binary codes B₁ and all the second binary codes B₂ can be accomplished in a software form. However, the present invention is not limited thereto, and in other embodiments, foregoing operations may also be accomplished through the hardware structure illustrated in FIG. 11. To be specific, the sensing signals Vᵥ of the visible light sensors Sᵥ are converted into the first binary codes B₁ by using a comparator CP1, the sensing signals Vᵢ of the invisible light sensors Sᵢ are converted into the second binary codes B₂ by using a comparator CP2, and the AND operation is performed on all the first binary codes B₁ and all the second binary codes B₂ by using a NAND gate and an inverter, so as to output the logic operation values C.

In addition, after performing the AND operation on all the first binary codes B₁ and all the second binary codes B₂ to determine the area actually touched by the user, a center point operation is further performed on the touch area (step S304) to obtain a touch parameter of the position touched by the user on the optical touch panel 100. In the present embodiment, the center point operation may be performed through a connected component labeling technique. However, the present invention is not limited thereto, and in other embodiments, the center point operation may also be performed through other suitable techniques. After performing the center point operation on the touch area, whether the touch area is larger than a predetermined area is determined (step S305). If the touch area is larger than the predetermined area (i.e., “yes”), all the logic operation values C having logic “1” are set to logic “0” (step S306). If the touch area is not larger than the predetermined area (i.e., “no”), the touch parameter is output (step S307) to trigger a corresponding operation of the optical touch panel 100.

FIG. 12 is a diagram illustrating the operation of an optical touch panel according to an embodiment of the invention. Referring to FIG. 12, for example, when the user places an entire hand H on the touch surface Sₜ of the optical touch panel 100 and it is determined in step S305 that the touch area (Area) is larger than the predetermined area (for example, 50%-70% of the surface area of the touch surface Sₜ, but not limited thereto), all the logic operation values C having logic “1” are set to logic “0” (i.e., it is considered that the user does not really want to perform any operation on the optical touch panel 100). In other words, if the user does not really want to perform any operation on the optical touch panel 100 but simply puts his/her hand on the touch surface Sₜ of the optical touch panel 100, any misoperation of the optical touch panel 100 is avoided.

In summary, in the touch position locating method provided by the invention, a position touched by a user on an optical touch panel can be precisely located after an AND operation is performed on the first binary codes and the second binary codes respectively converted from sensing signals of the visible light sensors and the invisible light sensors. Thereby, the touch position can be located without being affected by the ambient light, and any misoperation produced by the optical touch panel due to intensive ambient light can be avoided.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method of locating a touch position, adaptable to an optical touch panel, wherein the optical touch panel has a plurality of visible light sensors and a plurality of corresponding invisible light sensors that are arranged as an array, the method comprising:
reading sensing signals of the visible light sensors and the invisible light sensors;
converting the sensing signal of each of the visible light sensors into a first binary code according to a first setting parameter, and converting the sensing signal of each of the invisible light sensors into a second binary code according to a second setting parameter and a third setting parameter; and
performing a logic AND operation on all the first binary codes and all the second binary codes to obtain a plurality of logic operation values, so as to determine a position touched by a user on the optical touch panel.

2. The method according to claim 1, wherein when the logic operation values are all logic “0”, it is determined that the user does not touch the optical touch panel.

3. The method according to claim 1, wherein when a part of the logic operation values is logic “1”, it is determined that the user touches the optical touch panel.

4. The method according to claim 3, wherein the visible light sensors and invisible light sensors corresponding to all the logic operation values having logic “1” cover at least a touch area on the optical touch panel, and the method further comprises:
performing a center point operation on the touch area to obtain a touch parameter of the position touched by the user on the optical touch panel.

5. The method according to claim 4, wherein after performing the center point operation on the touch area, the method further comprises:
determining whether the touch area is larger than a predetermined area.

6. The method according to claim 5, wherein when the touch area is larger than the predetermined area, all the logic operation values having logic “1” are set to logic “0”, and when the touch area is not larger than the predetermined area, the touch parameter is output to trigger a corresponding operation of the optical touch panel.

7. The method according to claim 1, wherein when the sensing signals of the visible light sensors and the invisible light sensors are read, the method further comprises:
eliminating noises in the sensing signals of the visible light sensors and the invisible light sensors through a mean filtering technique.

8. The method according to claim 1, wherein before converting the sensing signals of the visible light sensors and the invisible light sensors, the method further comprises:
performing a remedy mechanism on the sensing signals of damaged visible light sensors and invisible light sensors.

9. The method according to claim 8, wherein the remedy mechanism comprises:
remedying the sensing signals of the damaged visible light sensors according to the sensing signals of a part of the undamaged visible light sensors; and
remedying the sensing signals of the damaged invisible light sensors according to the sensing signals of a part of the undamaged invisible light sensors.

10. The method according to claim 9, wherein
the part of the undamaged visible light sensors is adjacent to the damaged visible light sensors; and
the part of the undamaged invisible light sensors is adjacent to the damaged invisible light sensors.

11. The method according to claim 10, wherein
the sensing signals of the remedied visible light sensors are at least interpolation values of the sensing signals of the part of the undamaged visible light sensors; and
the sensing signals of the remedied invisible light sensors are at least interpolation values of the sensing signals of the part of the undamaged invisible light sensors.
